(19) United States
(12) Patent Application Publication
(10) Pub. No.: US 2007/0279612 A1
(43) Pub. Date: Dec. 6, 2007

(54) LIGHT MIXING DEVICE, IN PARTICULAR FOR A MICROLITHOGRAPHIC PROJECTION EXPOSURE APPARATUS

(75) Inventor: Manfred Maul, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/697,078

(22) Filed: Apr. 5, 2007

Related U.S. Application Data
(60) Provisional application No. 60/792,232, filed on Apr. 13, 2006.

(30) Foreign Application Priority Data
Apr. 13, 2006 (DE) 10 2006 017 894.7

(51) Int. Cl. G03B 27/52; G02B 27/00

(52) U.S. Cl. 355/67; 359/613

(57) ABSTRACT

The disclosure relates to a light mixing device, comprising a first arrangement composed of first beam-deflecting elements and a second arrangement composed of second beam-deflecting elements, each of the first beam-deflecting elements being assigned a second beam-deflecting element, which, upon irradiation of the light mixing device with a beam bundle, receives a partial beam of the beam bundle that has been deflected by the respective first beam-deflecting element and deflects it in a direction parallel to the propagation direction of the partial beam upstream of the first beam-deflecting element, wherein the first arrangement and the second arrangement are coordinated with one another in such a way that the beam bundle, after exiting from the second arrangement, over the beam bundle cross section, is composed alternately of partial beams that were arranged on one side of a central plane before entering into the light mixing device and partial beams that were arranged on the other side of the central plane before entering into the light mixing device, wherein the central plane subdivides the beam bundle into two half sections.

### CROSS-REFERENCE TO RELATED APPLICATION

This application claims priority under 35 U.S.C. §119(e)(1) to U.S. Provisional Application No. 60/792,232 filed Apr. 13, 2006. This applications also claims priority under 35 U.S.C. §119 to German Patent Application DE 10 2006 017 894.7, filed Apr. 13, 2006. The contents of both of these applications are hereby incorporated by reference.

### FIELD

The disclosure relates to a light mixing device, in particular a light mixing device for an illumination device of a microlithographic projection exposure apparatus.

### BACKGROUND

Microlithography is employed for producing microstructured components such as, for example, integrated circuits or LCDs. The microlithography process is carried out in a so-called projection exposure apparatus having an illumination device and a projection objective. The image of a mask (=reticle) illuminated via the illumination device having a laser light source is projected via the projection objective onto a substrate (e.g. a silicon wafer) which is coated with a light-sensitive layer (e.g. photoresist) and is arranged in the image plane of the projection objective, in order to transfer the mask structure to the light-sensitive coating of the substrate.

Laser profiles, in particular of an excimer laser typically used in the illumination device, are greatly dependent on the state of the laser (heating, gas filling, electrode erosion, laser mirror degradation) and therefore have asymmetrical profiles which fluctuate in terms of the dimensions and are also temporally unstable. In the illumination device this leads to problems in so far as the laser beam profile is transferred into the mask plane in convolved fashion with the intensity distribution generated by a field-generating element, the image field position being determined substantially by the geometrical position of the laser profile. In this case, beaming systems which regulate to the centroid of the intensity distribution may lead to erroneous corrections in the case of asymmetrical profiles which fluctuate in terms of the dimensions.

In order to illuminate the mask as uniformly and homogeneously as possible, it is known to use in the illumination device light mixing devices for homogenizing the laser light generated by the laser light source. Light mixing devices for homogenization which operate with diffusing screens or specially designed microlens systems are known, in particular. However, these introduce light conductance (also referred to as “Etendue”) into the system. Although the introduction of light conductance is comparatively unproblematic in laser machining equipment, it greatly restricts the minimum pupil filling that can be obtained in an illumination device of a microlithographic projection exposure apparatus.

### SUMMARY

The present disclosure provides a light mixing device for an illumination system, in particular an illumination device of a microlithographic projection exposure apparatus, which enables an efficient homogenization of the laser light generated by a laser light source, without introduction of light conductance.

A light mixing device according to the disclosure comprises:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element and deflects it in a direction parallel to the propagation direction of the partial beam upstream of the first beam-deflecting element;
wherein the first arrangement and the second arrangement are coordinated with one another in such a way that the beam bundle, after exiting from the second arrangement, over the beam bundle cross section, is composed alternately of partial beams that were arranged on one side of a central plane before entering into the light mixing device and partial beams that were arranged on the other side of the central plane before entering into the light mixing device, wherein the central plane subdivides the beam bundle into two half sections.

The disclosure, via the use of two mutually matched arrangements composed of beam-deflecting elements, provides an overall arrangement which enables, in particular, the exchange of individual partial beams of the laser light radiated in and hence a particularly efficient intermixing of the laser light, an introduction of light conductance simultaneously being avoided. In particular, the disclosure affords the possibility, in the case of a suitable relative arrangement of the beam-deflecting elements, i.e. upon targeted selection of the partial beams respectively exchanged in their position in the beam bundle via the light mixing device, of achieving a composition of the beam bundle emerging from the light mixing device such that the emerging laser beam is subjected to considerably reduced fluctuations with regard to centroid position and magnitude in the intensity profile.

In accordance with some embodiments, the first arrangement and the second arrangement are coordinated with one another in such a way that at least two partial beams which, before entering into the light mixing device, are arranged on mutually opposite sides of a central plane that runs through the beam bundle in the propagation direction and subdivides the beam bundle into two half sections, are arranged on the respective other side of the central plane after exiting from the light mixing device. In other words, therefore, at least two partial beams which are arranged in mutually different cross-sectional halves of the beam bundle before entering into the light mixing device can be arranged in the respective other cross-sectional half of the beam bundle after exiting from the light mixing device.

In accordance with some embodiments, the exit position of one respective partial beam of the two partial beams within the beam bundle cross section upon exiting from the light mixing device corresponds to the entrance position of the respective other of the two partial beams within the beam bundle cross section upon entering into the light mixing device.

In accordance with certain embodiments, the entrance position for one of the at least two partial beams is a marginal position within the beam bundle cross section, and the entrance position for the other of the at least two partial beams is a central position within the beam bundle cross section. An exchange of inner for outer partial beams is achieved in this way, which has the consequence, in particular, that that part of the profile of the beam bundle which is central (and better defined) before entering into the light mixing device becomes the marginal beam, and, therefore, irrespective of the actual original width of the beam bundle before entering into the light mixing device, the geometrical width of the beam bundle after exiting from the light mixing device is substantially constant. Furthermore, the intermixing of central and near-marginal partial beams of the beam bundle has the consequence that although the intensity profile of the beam bundle after exiting from the light mixing device has locally greater fluctuations, the intensity profile becomes more homogeneous on average.

In accordance with some embodiments, for the at least two partial beams, the respective entrance positions are at substantially the same distance from a central position (or the central plane) within the beam bundle, as a result of which it is possible to achieve a particularly soft course in the intensity profile of the beam bundle after exiting from the light mixing device.

In accordance with some embodiments, the first arrangement and the second arrangement are coordinated with one another in such a way that, in each case for a partial beam arranged between two partial beams deflected by beam-deflecting elements of the first arrangement, the exit position within the beam bundle cross section is identical to the entrance position within the beam bundle cross section.

In accordance with some embodiments, the first arrangement and the second arrangement are coordinated with one another in such a way that the beam bundle, after exiting from the second arrangement, over the beam bundle cross section, is composed alternately of partial beams that were arranged on one side of the central plane before entering into the light mixing device and partial beams that were arranged on the other side of the central plane before entering into the light mixing device. In other words, the beam bundle after exiting from the second arrangement can be composed of partial beams whose entrance position lies alternately in one cross-sectional half of the beam bundle and the other cross-sectional half of the beam bundle. What can be achieved in this way, for example, is that the beam bundle after exiting from the light mixing device is composed alternately of portions of the upper and the lower half of the beam bundle before entering into the light mixing device, whereby a particularly effective intermixing is obtained.

In accordance with certain embodiments, the first arrangement composed of first beam-deflecting elements and the second arrangement composed of second beam-deflecting elements are in each case formed mirror-symmetrically with respect to a system axis of the light mixing device.

The beam-deflecting elements may be formed refractively as prisms, in particular in the form of wedge plates, reflectively as mirrors or else diffractively as gratings.

The present disclosure also comprises and covers arrangements in which the beam bundle or the partial beams, respectively, are orientated after exit of the light mixing device at an angle to the beam bundle or the partial beams, respectively, before entrance to the light mixing device. Such arrangements can e.g. be realized by modifying the second arrangement while using additional wedge elements that deflect the beam bundle, or the partial beams, respectively, by such an angle, wherein an introduction of light conductance is still avoided.

According to a further aspect, a light mixing device comprises:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element and deflects it in a direction parallel to the propagation direction of the partial beam upstream of the first beam-deflecting element;
wherein the first arrangement and the second arrangement are coordinated with one another in such a way that, in each case for a partial beam arranged between two partial beams deflected by beam-deflecting elements of the first arrangement, the exit position within the beam bundle cross section upon exiting from the light mixing device is identical to the entrance position within the beam bundle cross section upon entering into the light mixing device.

According to a further aspect, a light mixing device comprises:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element;
wherein the first arrangement and the second arrangement are coordinated with one another in such a way that, in each case for a partial beam arranged between two partial beams deflected by beam-deflecting elements of the first arrangement, the exit position within the beam bundle cross section upon exiting from the light mixing device is identical to the entrance position within the beam bundle cross section upon entering into the light mixing device.

According to a further aspect, a light mixing device comprises:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element;
wherein the first arrangement and the second arrangement are coordinated with one another in such a way that the beam bundle, after exiting from the second arrangement, over the beam bundle cross section, is composed alternately of partial beams that were arranged on one side of a central plane before entering into the light mixing device and partial beams that were arranged on the other side of the central plane before entering into the light mixing device, wherein the central plane subdivides the beam bundle into two half sections.

According to a further aspect, a light mixing device comprises:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element;
wherein at least one of the prisms is produced from a birefringent material.

According to a further aspect, a light mixing device comprises:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element;
wherein at least one of the prisms is produced from an optically active material.

The disclosure furthermore relates to an optical system, in particular an illumination device, comprising a laser source and at least one light mixing device according to the disclosure arranged in the beam path of the laser source, and to a microlithographic projection exposure apparatus.

Further configurations of the disclosure can be gathered from the description and also the subclaims.

The disclosure is explained in more detail below on the basis of exemplary embodiments illustrated in the accompanying figures.

### BRIEF DESCRIPTION OF THE DRAWINGS

In the drawings:

FIG. 1 shows a schematic illustration for elucidating the construction of a light mixing device according to an embodiment of the disclosure;

FIG. 2 shows a diagram for elucidating the construction of a light mixing device according to an embodiment of the disclosure;

FIGS. 3a-d show, for different intensity profiles of a beam bundle impinging on the light mixing device formed in accordance with the assignment table from FIG. 2, in each case the associated intensity profile—determined via simulation—upon exiting from the light mixing device;

FIG. 4 shows a diagram for elucidating the construction of a light mixing device according to an embodiment of the disclosure;

FIGS. 5a-d show, for different intensity profiles of a beam bundle impinging on the light mixing device formed in accordance with the assignment table from FIG. 4, in each case the associated intensity profile—determined via simulation—upon exiting from the light mixing device;

FIGS. 6, 7 show schematic illustrations for elucidating the construction of beam-deflecting elements used in a light mixing device according to certain embodiments of the disclosure; and

FIG. 8 shows a schematic illustration of the construction of a microlithographic projection exposure apparatus in whose illumination device a light mixing device according to the disclosure is used.

### DETAILED DESCRIPTION

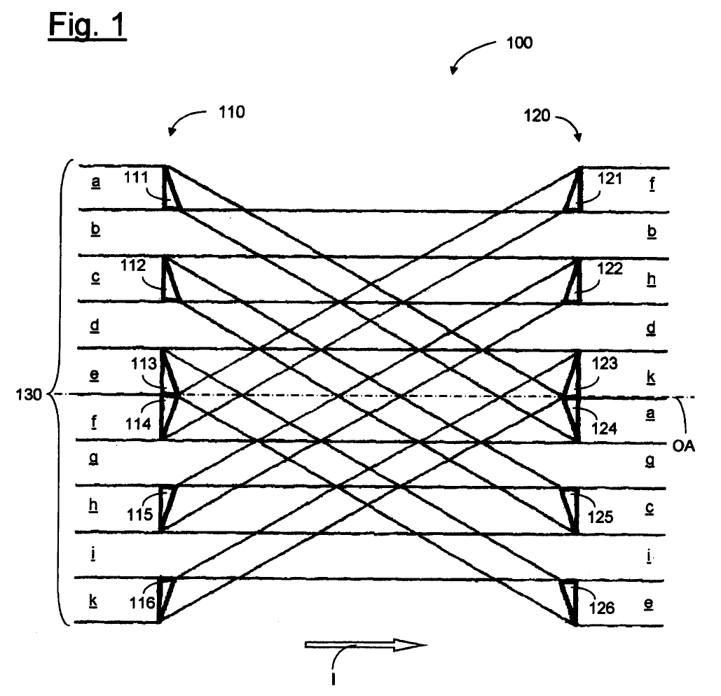

Firstly, an explanation is given of an embodiment the construction of a light mixing device according to the disclosure with reference to the schematic illustration of FIG. 1.

The light mixing device 100 has a first arrangement 110 composed of a total of six first beam-deflecting elements 111-116 and a second arrangement 120 composed of a total of six second beam-deflecting elements 121-126, the beam-deflecting elements in accordance with FIG. 1 being formed in each case in the form of prisms configured as wedge plates. The arrangements 110 and 120 can be fitted on a carrier that is transparent to the respective operating wavelength. As an alternative, the arrangements 110 and 120 can also be arranged in a (e.g. self-supporting) frame.

The prisms or wedge plates comprise a material (e.g. quartz glass) that is transmissive to the respective operating wavelength. Optionally, the material is a birefringent or optically active material being specified further below.

In this case, the wedge plates 111-116 of the first arrangement 110 in each case have a planar light entrance surface perpendicular to the system axis OA, and the wedge plates 121-126 of the second arrangement 120 have a planar light exit surface perpendicular to the system axis OA. As can likewise be discerned, the first arrangement 110 composed of wedge plates 111-116 and the second arrangement 120 composed of the wedge plates 121-126 are in each case formed mirror-symmetrically with respect to the system axis OA of the light mixing device 100.

In addition, for respectively mutually assigned wedge plates of the first arrangement 110 and the second arrangement 120, the respectively oblique surfaces (that is to say the light exit surface of the respective first wedge plate and the light entrance surface of the respective second wedge plate) are parallel to one another. Consequently, in each case the second wedge plate of the arrangement 120 receives that partial beam of a beam bundle 130 (which is incident in light propagation direction “I”) which has been deflected by the respectively assigned first wedge plate of the first arrangement 110, and deflects it parallel to the original propagation direction, that is to say in a direction which is parallel to the propagation direction of the partial beam upstream of the first wedge plate.

In the concrete exemplary embodiment, the respectively mutually assigned wedge plates are formed by the pairs composed of the wedge plates 111 and 124, 112 and 125, 113 and 126, 114 and 121, 115 and 122, and 116 and 123. These mutually assigned wedge plates may to an extent also be regarded as double wedge composed of two wedge plates which are off-set relative to one another in directions parallel and perpendicular to the system axis.

As can further be seen from FIG. 1, the wedge plates that are in each case arranged successively transversely with respect to the system axis in the arrangements 110 and 120 are arranged at a constant distance from one another. Consequently, as can be discerned from the courses—which are shown schematically on the basis of the solid lines—of the individual partial beams of the beam bundle 130 impinging on the first arrangement 110, in each case for some of the partial beams (numbered consecutively from top to bottom by “a” to “k”) which are arranged between two partial beams deflected by wedge plates of the first arrangement 110, the exit position within the beam bundle upon exiting from the light mixing device is identical to the entrance position within the beam bundle upon entering into the light mixing device. This is the case for the partial beams b, d, g and i in the exemplary embodiment of FIG. 1.

For the remaining partial beams, that is to say the partial beams deflected by the wedge plates of the first arrangement 110 and the wedge plates of the second arrangement 120 in the manner that is described above and can be seen from FIG. 1, respective pairs composed of two partial beams in each case can be established for which—owing to the above-described coordination of the first arrangement 110 and the second arrangement 120 in relation to one another and also their mirror-symmetrical formation with respect to the system axis OA of the light mixing device 100—an exit position of one partial beam of the pair within the beam bundle 130 upon exiting from the light mixing device 100 corresponds to an entrance position of the respective other partial beam of the pair within the beam bundle upon entering into the light mixing device 100. In other words, the light mixing device has the effect that in each case two light beams exchange their position within the beam bundle owing to the passage through the light mixing device. This is the case for the pairs composed of the partial beams a and f, c and h and e and k, in accordance with the exemplary embodiment illustrated in FIG. 1.

While the partial beams a and k before entering into the light mixing device are marginal rays of the beam bundle 130, the partial beams e and f before entering into the light mixing device constitute partial beams near the center, that is to say partial beams of the beam bundle 130 that are arranged near the system axis OA of the light mixing device 100. In this case, the above position exchange within the beam bundle 130 for the pairs composed of the partial beams a and f, c and h and e and k, owing to the passage through the light mixing device 100 is effected in such a way that the partial beams e and f entering into the light mixing device 100 as rays near the center have become marginal rays after exiting from the light mixing device 100, and conversely the partial beams a and k entering into the light mixing device 100 as marginal rays have become rays near the center after exiting from the light mixing device 100. For the further partial beam c, in accordance with FIG. 1, a position exchange takes place with the partial beam h, which, before entering into the light mixing device 100, is at the same distance away from the system axis OA and is arranged on the opposite side thereof.

A further systematism of the intermixing brought about by the light mixing device 100 from FIG. 1 consists, in accordance with FIG. 1, in the fact that the partial beams of the beam bundle after exiting from the second arrangement 120 originate alternately from the group of partial beams a-e which are associated with the upper half of the beam bundle 130 upon entering into the first arrangement 110, and from the group of partial beams f-k which are associated with the lower half of the beam bundle 130 upon entering into the first arrangement 110. In this case, the expressions “upper half” and “lower half” should be understood in relation to a fictitious central plane which runs in the propagation direction (and perpendicular to the plane of the drawing in FIG. 1) and which subdivides the beam bundle into two half sections (that is to say an upper half and a lower half).

It goes without saying that the disclosure is not restricted to the number of beam-deflecting elements illustrated in FIG. 1. Generally, an analogous construction to FIG. 1 of a light mixing device for intermixing a number of N=2+4*m partial beams (where m is an integer greater than or equal to zero) has a number P=N/2+1 of beam-deflecting elements per arrangement of the two arrangements coordinated with one another. For the example of FIG. 1, m=2 (that is to say intermixing of a total of 10 partial beams) and P=6 (that is to say a total of 6 beam-deflecting elements or wedge plates per arrangement).

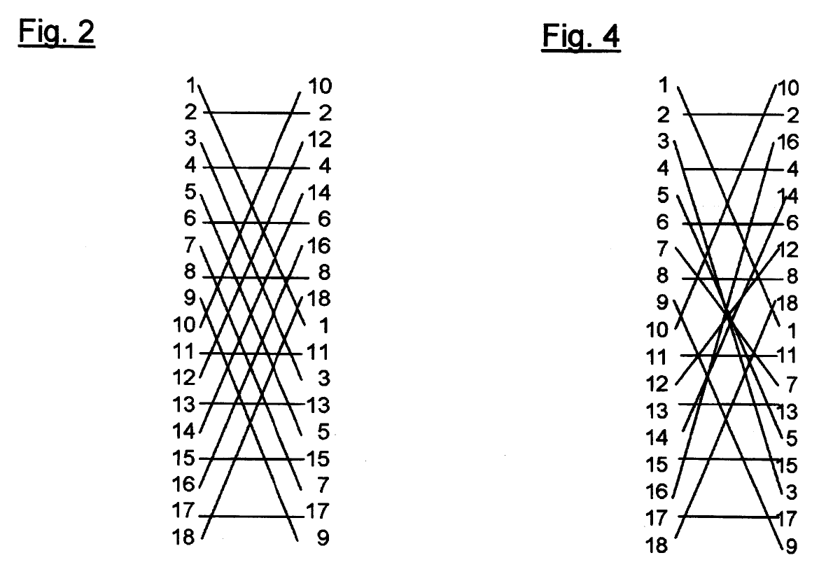

FIG. 2 illustrates, on the basis of an assignment table, the construction of a light mixing device according to an embodiment the disclosure, where N=18 partial beams (consecutively numbered by numerals 1-18 in FIG. 2) are intermixed by P=10 beam-deflecting elements per arrangement. For the rest, the structural principle in accordance with FIG. 2 corresponds to that of the light mixing device from FIG. 1; in this case, partial beams (the partial beams 7, 9, 10 and 12 in the example) entering into the light mixing device as rays near the center have become marginal rays after exiting from the light mixing device, and conversely the partial beams (the partial beams 1, 3, 16 and 18 in the example) entering into the light mixing device as marginal rays have become rays near the center after exiting from the light mixing device. In accordance with FIG. 2, for the further partial beam 5, a position exchange takes place with the partial beam 14, which, before entering into the light mixing device, is at the same distance away from the system axis and is arranged on the opposite side thereof.

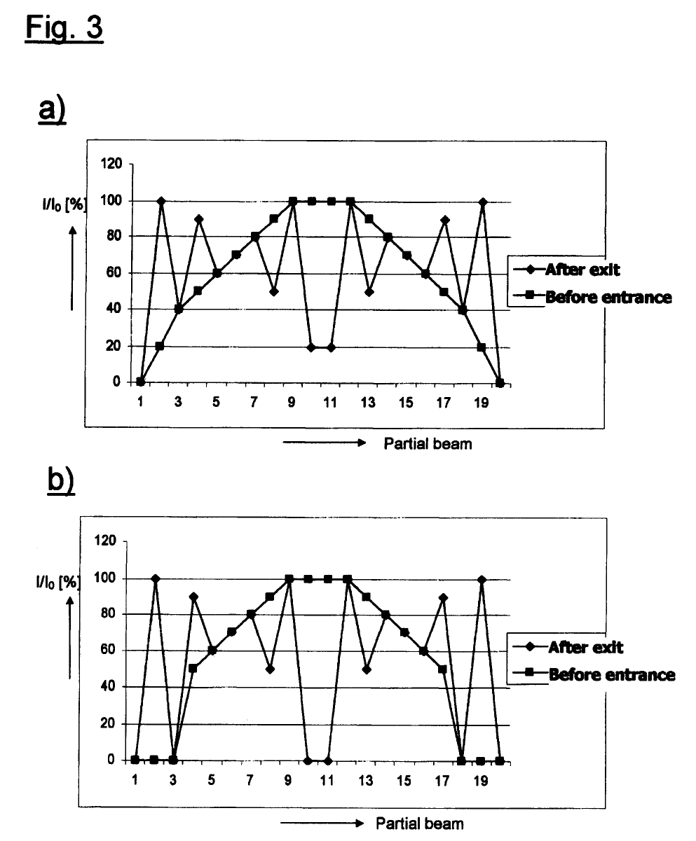

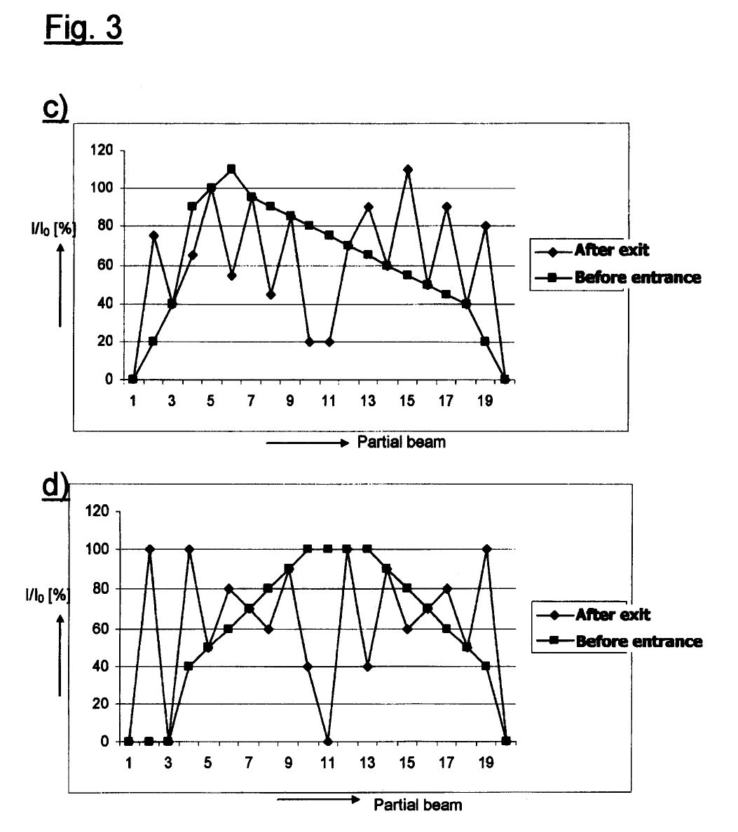

FIGS. 3a-d show, for different intensity profiles of a beam bundle impinging on the light mixing device formed in accordance with the assignment table from FIG. 2, in each case the associated intensity profile—determined via simulation—upon exiting from the light mixing device. In this case, in accordance with FIGS. 3a and 3b, the intensity profile in each case runs symmetrically over the extent of the beam bundle, the extent being smaller by 20% for the intensity profile of FIG. 3b than for the intensity profile of FIG. 3a. FIGS. 3c and 3d in each case show different asymmetrical intensity profiles with centroid offset (FIG. 3c) and offset of the entire intensity profile (FIG. 3d).

As can be discerned in each case from FIGS. 3a and 3b, although the intensity profile after exiting from the light mixing device has locally greater fluctuations of the intensity in comparison with the intensity profile upon entering into the light mixing device, it runs more homogeneously on average. A comparison of the intensity profiles of FIG. 3b with those of FIG. 3a shows that despite the significant difference in the width of the intensity profiles upon entering into the light mixing device, the intensity profiles after exiting from the light mixing device differ from one another only by approximately 1.5%.

The effect on an intensity profile that is asymmetrical upon entering into the light mixing device can be discerned from FIG. 3c. In this case, the width of the intensity profile is only 3% smaller than in the case of a symmetrical intensity profile (in accordance with FIG. 3a). The asymmetrical intensity profile upon entering into the light mixing device in accordance with FIG. 3c has a centroid offset by 5% relative to the symmetrical intensity profile in accordance with FIG. 3a. By contrast, the intensity profile after exiting from the light mixing device in accordance with FIG. 3c only has a centroid offset by approximately 0.7%. In this case, the “width” of the intensity profile should be understood as the second moment of the intensity profile, which is given by the expression

$$\frac{\int I ( x ) * {x}^{2} d x}{\int I ( x ) * d x} .$$

### The “centroid” of the intensity profile should be understood as the first moment of the intensity profile, which is given by the expression

$$\frac{\int I ( x ) * x d x}{\int I ( x ) * d x}$$

(where I(x) denotes the intensity dependent on the spatial coordinate x).

The asymmetrical intensity profile upon entering into the light mixing device in accordance with FIG. 3d has an offset by 5% relative to that in the case of the symmetrical intensity profile (in accordance with FIG. 3b). The offset, as can be discerned on the basis of the intensity profile after exiting from the light mixing device in accordance with FIG. 3d, leads only to a centroid offset by approximately 1.2%.

FIG. 4 illustrates, on the basis of an assignment table, the construction of a light mixing device according to an embodiment of the disclosure, where N=18 partial beams (consecutively numbered by numerals 1-18 in FIG. 4) are intermixed by P=10 beam-deflecting elements per arrangement in the same way as in FIG. 2. In a modification of the structural principle explained with reference to FIG. 2, in the case of the light mixing device constructed in accordance with FIG. 4, here a position exchange near-marginal/near-center takes place only for the outermost partial beams 1, 18 upon entering into the light mixing device with the innermost partial beams 9, 10 upon entering into the light mixing device. For the rest of the partial beams, either no position exchange takes place (in this respect still analogous to the structural principle of FIG. 2), as is the case for the partial beams 2, 4, 6, 8, 11, 13, 15 and 17 in accordance with FIG. 4, or a position exchange takes place with a respective partial beam which, before entering into the light mixing device, is at the same distance away from the system axis OA and is arranged on the opposite side thereof as is the case for the pairs composed of position-exchanging partial beams 3 and 16, 5 and 14, and 7 and 12, in accordance with FIG. 4.

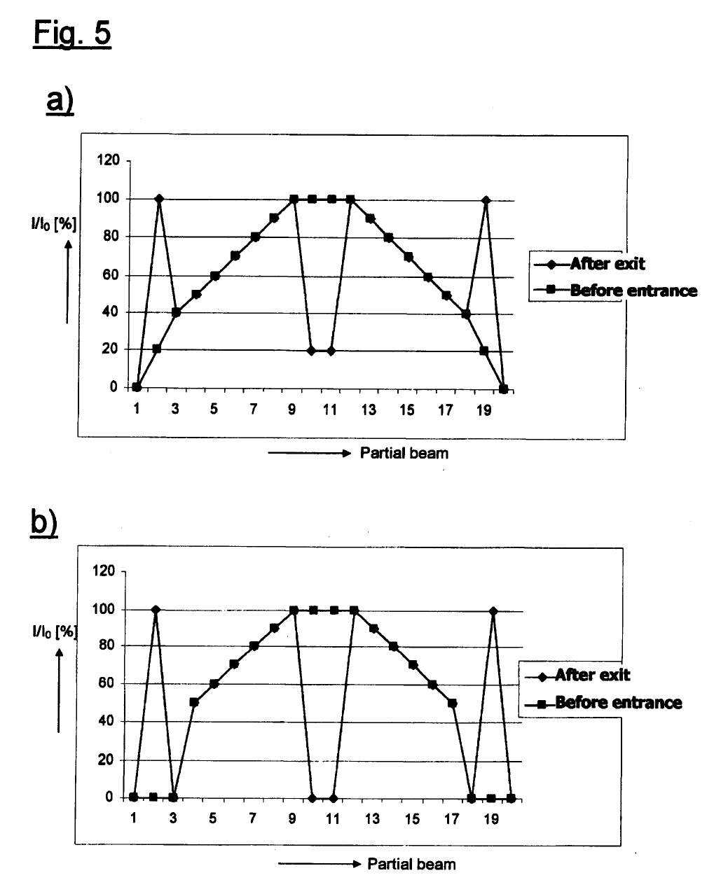

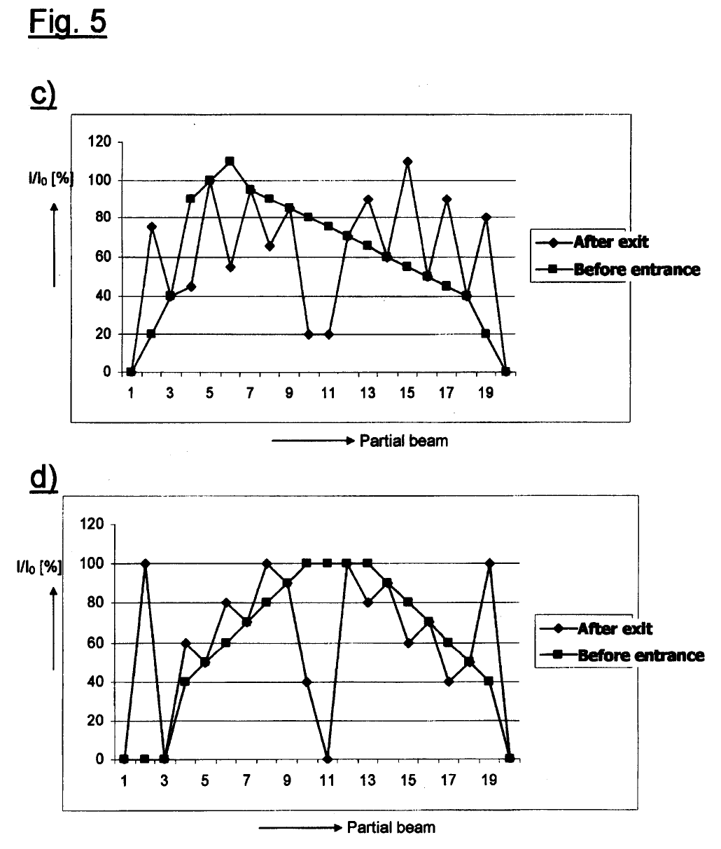

FIGS. 5a-d show, for different intensity profiles of a beam bundle impinging on the light mixing device formed in accordance with the assignment table from FIG. 4, in each case the associated intensity profile—determined via simulation—upon exiting from the light mixing device. In this case, in accordance with FIGS. 5a and 5b, the intensity profile in each case runs symmetrically over the extent of the beam bundle, the extent being smaller by 20% for the intensity profile of FIG. 5b than for the intensity profile of FIG. 5a. FIGS. 5c and 5d in each case show different asymmetrical intensity profiles with centroid offset (FIG. 5c) and offset of the entire intensity profile (FIG. 5d).

A comparison of the intensity profiles of FIG. 5b with those of FIG. 5a shows that, despite the significant difference (of once again 20%) in the width of the intensity profiles upon entering into the light mixing device, the intensity profiles after exiting from the light mixing device differ only little (by approximately 2%) from one another. The asymmetrical intensity profile upon entering into the light mixing device in accordance with FIG. 5c has a centroid offset by 5% relative to that in the case of the symmetrical intensity profile (in accordance with FIG. 5a). By contrast, the intensity profile after exiting from the light mixing device in accordance with FIG. 5c only has a centroid offset by approximately 1% (that is to say that the efficiency in the correction of “skew” intensity distributions is somewhat lower than in the embodiment described with reference to FIGS. 2 and 3). The asymmetrical intensity profile upon entering into the light mixing device in accordance with FIG. 5d has an offset by 5% relative to the symmetrical intensity profile in accordance with FIG. 5b. The offset, as can be discerned on the basis of the intensity profile after exiting from the light mixing device in accordance with FIG. 5d, leads to a centroid offset by approximately 1.2% (with the result that, in this respect, the effect is identical to that in the embodiment described with reference to FIGS. 2 and 3).

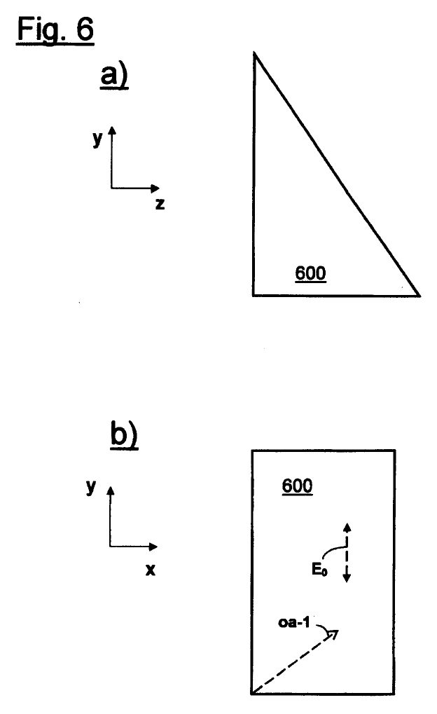

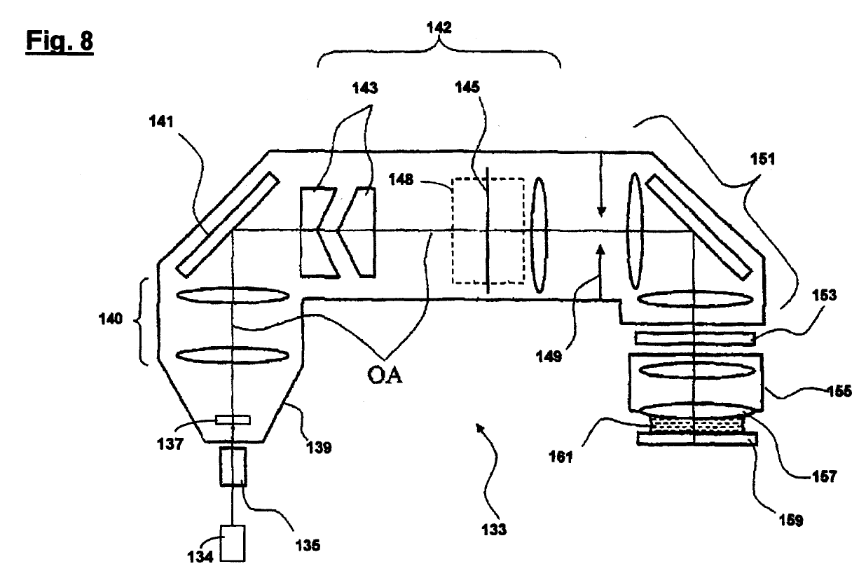

In accordance with a further embodiment, the light mixing device according to the disclosure can be developed for obtaining a depolarizing effect. For this purpose, in particular at least one of the wedge plates (designated by 600 in FIGS. 6a and 6b) may be produced from a birefringent, in particular an optically uniaxial crystal material in such a way that the optical crystal axis oa-1 is oriented substantially perpendicular to the system axis OA of the light mixing device (that is to say lies in the x-y plane in accordance with the system of coordinates specified in FIG. 6). This wedge plate is furthermore arranged analogously to a Hanle depolarizer in accordance with the schematic illustration of FIGS. 6a and 6b such that the angle between the optical crystal axis oa-1 of the birefringent material and the vibration direction of the electric field strength vector (designated by E₀ and running in the y direction in FIG. 6b) of the linearly polarized light coming from the laser source is substantially 45°. A wedge plate of this type brings about, analogously to the functioning of a Hanle depolarizer, for linearly polarized light passing through it, a variation of the polarization direction over the light bundle cross section, these different polarization states in turn being superimposed by subsequent light intermixing components (cf. for instance reference symbols 137 and 148 in FIG. 8, which is explained further below). Light mixing systems of this type are known for example from DE 100 10 131 A1 or EP 1 577 709 A2.

In some embodiments, for instance proceeding from the exemplary embodiment of FIG. 1, all the wedge plates of the first arrangement 110, as described above, may also be formed from optically uniaxial crystal material having the above crystal orientation in order to obtain a variation of the polarization direction over the entire beam bundle cross section owing to the wedge plates of the first arrangement, whereby substantially unpolarized light can be obtained again after intermixing in the light mixing device for instance in the illumination plane of an illumination device.

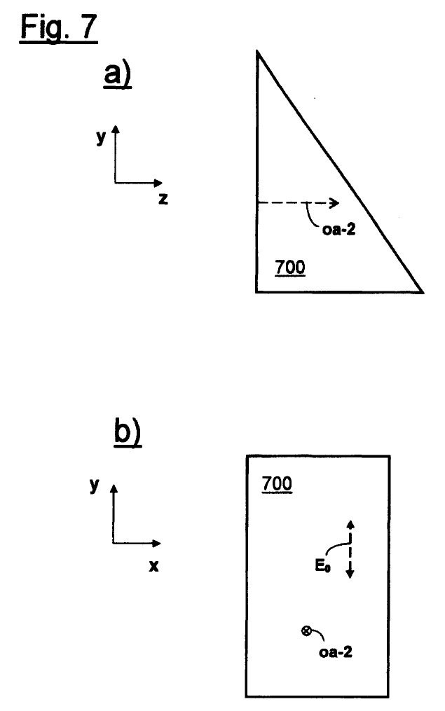

In accordance with a further embodiment, for instance proceeding from the exemplary embodiment of FIG. 1, at least one (designated by 700 in FIGS. 7a and 7b) wedge plate and optionally all the wedge plates of the first arrangement 110 may be produced from optically active crystal material (e.g. crystalline quartz), the optical crystal axis oa-2 in the optically active crystal material then being oriented substantially parallel to the system axis OA (that is to say running in the z direction in accordance with the system of coordinates specified in FIG. 7). On passage of light through such wedge plates, a rotation of the orientation of the polarization results, the rotation being dependent on the respective traversing material path in the optically active crystal material, in which case, once again after light exit from the optically active crystal material, the polarization states which are then oriented in all directions produce effectively unpolarized light upon superimposition in the illumination plane.

FIG. 8 shows, in a schematic illustration, a microlithography projection exposure apparatus 133 comprising a light source unit 134, an illumination device 139, a structure-carrying mask 153, a projection objective 155 and a substrate 159 to be exposed. The light source unit 134 may comprise as light source for example an ArF laser for an operating wavelength of 193 nm, and also a beam shaping optic that generates a parallel beam of light.

In accordance with the exemplary embodiment of FIG. 8, the parallel beam of light issuing from the light source 134 firstly impinges on a light mixing device 135 according to the disclosure, where it is intermixed in the manner described above without the light conductance already being increased by that point.

The light bundle subsequently impinges on a light-conductance-increasing element 137, which generates a desired intensity distribution, e.g. dipole or quadrupole distribution, via a through the respective diffractively or refractively beam-deflecting structure in a pupil plane 145. The light-conductance-increasing element 137 acts as a light intermixing component and superimposes many (typically >100) different regions of the laser beam in the pupil. Situated downstream of the light-conductance-increasing element 137 in the light propagation direction is a zoom objective 140, which generates a parallel beam of light having a variable diameter. The parallel beam of light is directed onto an optical unit 142 by a deflection mirror 141, the optical unit having an axicon 143. Via the zoom objective 140 in conjunction with the upstream light-conductance-increasing element 137 and the axicon 143, different illumination configurations are generated in the pupil plane 145 depending on zoom setting and position of the axicon elements. The optical unit 142 comprises, downstream of the axicon 143, a light mixing system 148 arranged in the region of the pupil plane 145, which light mixing system has a further light intermixing component, optionally a lens array or a fly's eye condenser for generating a field intensity distribution. Light mixing systems of this type are known for example from DE 100 10 131 A1 or EP 1 577 709 A2. The optical unit 142 is followed by a reticle masking system (REMA) 149, which is imaged onto the structure-carrying mask (reticle) 153 via an REMA objective 151 and thereby delimits the illuminated region on the reticle 153. The structure-carrying mask 153 is imaged onto a light-sensitive substrate 159 via a projection objective 155. In the exemplary embodiment illustrated, an immersion liquid 161 having a different refractive index from that of air is situated between a last optical element 157 of the projection objective 155 and the light-sensitive substrate 159.

Even though the disclosure has been described on the basis of specific embodiments, numerous variations and alternative embodiments can be deduced by the person skilled in the art, e.g. by combination and/or exchange of features of the individual embodiments. Accordingly, it goes without saying for the person skilled in the art that such variations and alternative embodiments are also encompassed by the present disclosure, and the scope of the disclosure is only restricted within the meaning of the accompanying patent claims and the equivalents thereof.

1. A light mixing device, comprising:
a first arrangement comprising first beam-deflecting elements and a second arrangement comprising second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element and deflects it in a direction parallel to the propagation direction of the partial beam upstream of the first beam-deflecting element;
wherein the first arrangement and the second arrangement are coordinated with one another in such a way that the beam bundle, after exiting from the second arrangement, over the beam bundle cross section, is composed alternately of partial beams that were arranged on one side of a central plane before entering into the light mixing device, and partial beams that were arranged on the other side of the central plane before entering into the light mixing device, wherein the central plane subdivides the beam bundle into two half sections.

2. The light mixing device according to claim 1, wherein the first arrangement and the second arrangement are coordinated with one another in such a way that at least two partial beams which, before entering into the light mixing device, are arranged on mutually opposite sides of the central plane, are arranged on the respective other side of the central plane after exiting from the light mixing device.

3. The light mixing device according to claim 1, wherein, for at least two partial beams, the exit position of one respective partial beam of the two partial beams within the beam bundle cross section upon exiting from the light mixing device corresponds to the entrance position of the respective other of the two partial beams within the beam bundle cross section upon entering into the light mixing device.

4. The light mixing device according to claim 2, wherein the respective entrance position within the beam bundle cross section upon entering into the light mixing device is a marginal position for one of the two partial beams and a central position within the beam bundle cross section for the other of the two partial beams.

5. The light mixing device according to claim 2, wherein, for the two partial beams, the respective entrance positions within the beam bundle cross section upon entering into the light mixing device are at substantially the same distance from the central plane.

6. The light mixing device according to claim 1, wherein the first arrangement and the second arrangement are coordinated with one another in such a way that, in each case for a partial beam arranged between two partial beams deflected by beam-deflecting elements of the first arrangement, the exit position within the beam bundle cross section upon exiting from the light mixing device is identical to the entrance position within the beam bundle cross section upon entering into the light mixing device.

7. The light mixing device according to claim 1, wherein the first arrangement composed of first beam-deflecting elements and the second arrangement composed of second beam-deflecting elements are in each case formed mirror-symmetrically with respect to a system axis of the light mixing device.

8. The light mixing device according to claim 1, wherein at least some of the first and/or second beam-deflecting elements are prisms.

9. The light mixing device according to claim 8, wherein at least one of the prisms is produced from a birefringent material.

10. The light mixing device according to claim 8, wherein at least one of the prisms is produced from an optically uniaxial crystal material having an optical crystal axis oriented substantially perpendicular to a system axis of the light mixing device.

11. The light mixing device according to claim 9, wherein the birefringent material is crystalline quartz.

12. The light mixing device according to claim 8, wherein at least one of the prisms is produced from an optically active material.

13. The light mixing device according to claim 12, wherein the optically active material is crystalline quartz having an optical crystal axis oriented substantially parallel to a system axis of the light mixing device.

14. The light mixing device according to claim 1, wherein at least one of the first beam-deflecting elements is a first wedge plate having a planar light entrance surface perpendicular to the light propagation direction, the assigned second beam-deflecting element being a second wedge plate having a planar light exit surface perpendicular to the light propagation direction.

15. The light mixing device according to claim 14, wherein at least one of the first beam-deflecting elements together with the second beam-deflecting element assigned to it forms an effectively depolarizing system, in particular a Hanle depolarizer.

16. The light mixing device according to claim 1, wherein at least some of the first and/or second beam-deflecting elements are mirrors.

17. The light mixing device according to claim 1, wherein it is designed for an operating wavelength of less than 250 nm.

18. An optical system, comprising
a laser source; and
at least one light mixing device according to claim 1, arranged in the beam path of the laser source.

19. A microlithographic projection exposure apparatus, comprising:
an illumination device and a projection objective, the illumination device illuminating an object plane of the projection objective, and the object plane being imaged into an image plane of the projection objective via the projection objective,
the illumination device being an optical system according to claim 18.

20. A light mixing device, comprising:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element and deflects it in a direction parallel to the propagation direction of the partial beam upstream of the first beam-deflecting element;
wherein the first arrangement and the second arrangement are coordinated with one another in such a way that, in each case for a partial beam arranged between two partial beams deflected by beam-deflecting elements of the first arrangement, the exit position within the beam bundle cross section upon exiting from the light mixing device is identical to the entrance position within the beam bundle cross section upon entering into the light mixing device.

21. A light mixing device, comprising:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element;
wherein the first arrangement and the second arrangement are coordinated with one another in such a way that, in each case for a partial beam arranged between two partial beams deflected by beam-deflecting elements of the first arrangement, the exit position within the beam bundle cross section upon exiting from the light mixing device is identical to the entrance position within the beam bundle cross section upon entering into the light mixing device.

22. A light mixing device, comprising:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element;
wherein the first arrangement and the second arrangement are coordinated with one another in such a way that the beam bundle, after exiting from the second arrangement, over the beam bundle cross section, is composed alternately of partial beams that were arranged on one side of a central plane before entering into the light mixing device and partial beams that were arranged on the other side of the central plane before entering into the light mixing device, wherein the central plane subdivides the beam bundle into two half sections.

23. A light mixing device, comprising:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element;
wherein at least one of the prisms is produced from a birefringent material.

24. A light mixing device, comprising:
a first arrangement composed of first beam-deflecting elements and a second arrangement composed of second beam-deflecting elements;
each of the first beam-deflecting elements being assigned a second beam-deflecting element, which, upon irradiation of the light mixing device with a beam bundle, receives a partial beam of the beam bundle that has been deflected by the respective first beam-deflecting element;
wherein at least one of the prisms is produced from an optically active material.
